(19) United States
(12) Patent Application Publication
(10) Pub. No.: US 2020/0410967 A1
(43) Pub. Date: Dec. 31, 2020

(54) METHOD FOR DISPLAYING TRIGGERED BY AUDIO, COMPUTER APPARATUS AND STORAGE MEDIUM

(71) Applicant: SHANGHAI EDAYSOFT CO., LTD., Shanghai (CN)

(72) Inventor: Hong Jiang, Shanghai (CN)

(73) Assignee: SHANGHAI EDAYSOFT CO., LTD., Shanghai (CN)

(21) Appl. No.: 16/657,139

(22) Filed: Oct. 18, 2019

(30) Foreign Application Priority Data
Jun. 28, 2019 (CN) 201910578564.6

(51) Int. Cl. G10H 1/00; H04R 5/04; G10H 1/40

(52) U.S. Cl. CPC G10H 1/0025; H04R 5/04; G10H 2220/081; G10H 2210/021; G10H 2220/086; G10H 1/40

(57) ABSTRACT

This disclosure relates to a method of displaying triggered by an audio, a computer apparatus, and a storage medium. The method comprises acquiring a background audio carrying a sound effect; playing the background audio, and generating a to-be-triggered area in a display page in response to playing to the sound effect; receiving an input trigger instruction, and detecting whether the trigger instruction matches the to-be-triggered area; displaying the to-be-triggered area according to a first preset effect in response to the trigger instruction matching the to-be-triggered area.

### CROSS REFERENCE TO RELATED APPLICATIONS

This application claims priority to Chinese patent application No. 2019105785646 entitled “METHOD AND DEVICE FOR DISPLAYING TRIGGERED BY AUDIO, COMPUTER APPARATUS AND STORAGE MEDIUM”, and filed on Jun. 28, 2019, the disclosure of which is herein incorporated in its entirety by reference.

### TECHNICAL FIELD

The present disclosure relates generally to the field of computer technology.

### BACKGROUND

With the development of computer technology and network information computing, people starts to transmit and publish information through the network. The network plays an important role in people's entertainment and work life. Digital audio has also become a mainstream form of network data. And with the development of the big data, the application of audio data will also become more and more extensive.

### SUMMARY

According to various embodiments of the present disclosure, a method, a computer apparatus, and a storage medium for displaying triggered by an audio are provided.

A method for displaying triggered by an audio comprises acquiring a background audio containing a sound effect; playing the background audio, and generating a to-be-triggered area in a display page in response to playing to the sound effect; receiving an input trigger instruction, and detecting whether the trigger instruction matches the to-be-triggered area; and displaying the to-be-triggered area according to a first preset effect, in response to the trigger instruction matching the to-be-triggered area.

A computer apparatus comprises one or more processors, and a memory storing computer-readable program, which, when executed by the one or more processors cause the one or more processors to perform the above mentioned method.

At least one one-transitory computer-readable storage medium comprises computer-readable instructions, which, when executed by one or more processors, cause the one or more processors to perform the above mentioned method.

The details of one or more implementations of the subject matter described in this specification are set forth in the accompanying drawings and the description below. Other potential features, aspects, and advantages of the subject matter will become apparent from the description, the drawings, and the claims.

### BRIEF DESCRIPTION OF THE DRAWINGS

To illustrate the technical solutions according to the embodiments of the present invention or in the prior art more clearly, the accompanying drawings for describing the embodiments or the prior art are introduced briefly in the following. Apparently, the accompanying drawings in the following description are only some embodiments of the present invention, and persons of ordinary skill in the art can derive other drawings from the accompanying drawings without creative efforts.

FIG. 1 is a schematic diagram illustrating an environment adapted for a method for displaying triggered by an audio in accordance with an embodiment.

FIG. 2 is a schematic flow chart illustrating a method for displaying triggered by an audio in accordance with an embodiment.

FIG. 3 is a flow chart illustrating acquiring the background audio containing the sound effect in accordance with an embodiment.

FIG. 4 is a flow chart illustrating instruction triggering in accordance with another embodiment.

FIG. 5 is a block diagram illustrating a device for displaying triggered by an audio in accordance with an embodiment.

FIG. 6 is a block diagram illustrating a computer apparatus for displaying triggered by an audio in accordance with an embodiment.

### DETAILED DESCRIPTION OF THE EMBODIMENTS

Embodiments of the invention are described more fully hereinafter with reference to the accompanying drawings. The various embodiments of the invention may, however, be embodied in many different forms and should not be construed as limited to the embodiments set forth herein. Rather, these embodiments are provided so that this disclosure will be thorough and complete, and will fully convey the scope of the invention to those skilled in the art.

As explained above, when displaying a multimedia effect on a display page, an instruction is manually given by a user to generate a display effect. If audio is used to control the display effect, usually a series of changes of display effect are preset. Then when playing the background music, the display effect is displayed in accordance with the sequence of the changes. However, in the conventional trigger manner for display effect, there is no actual connection between the background music and the display effect. When changing the background music, the display effect may not be integrated with the background music, which may result in a poor user's experience.

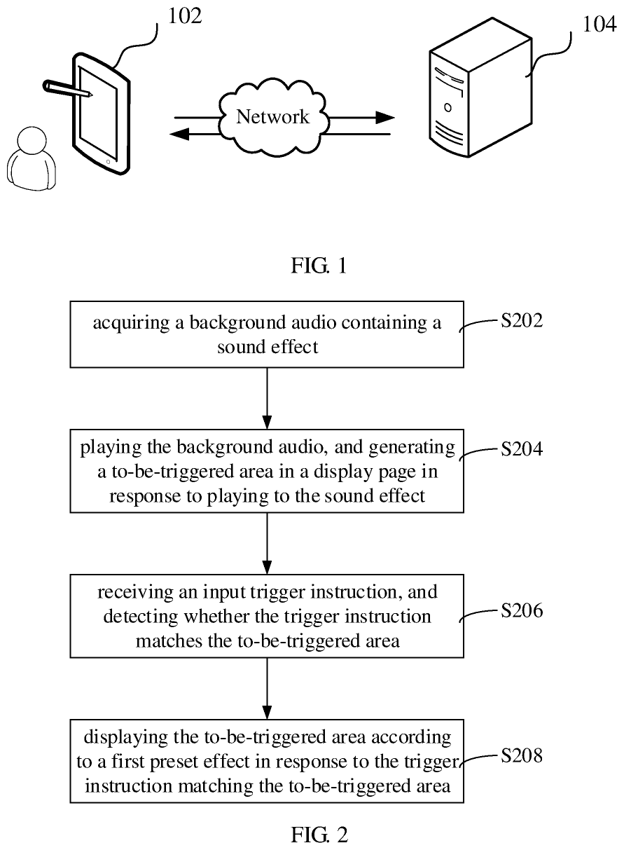

The method for displaying triggered by an audio in accordance with an embodiment can be implemented in an application environment as shown in FIG. 1. Terminal 102 communicates with server 104 over a network. An environment with which a method for displaying triggered by an audio can be performed is provided by the server 104 to the terminal 102. The environment is installed in the terminal 102. A preset multimedia information is displayed in a display page of the terminal 102 through the environment in response to playing a sound effect in a background audio. The terminal 102 can be, but is not limited to, various personal computers, notebook computers, smart phones, tablets, and portable wearable devices. The server 104 may be implemented as a stand-alone server or a server cluster composed of multiple servers.

As shown in FIG. 2, in an embodiment, a method for displaying triggered by an audio is provided. The terminal shown in FIG. 1 is taken as an example, and the method is applied on the terminal. The method comprises the following steps.

In step S202, a background audio containing a sound effect is acquired.

The background audio is an audio file containing a sound effect downloaded by a terminal from the server. It may be in a common audio format such as mp3, WMA, WAV, and the like. Specifically, the background audio is an audio file generated after adding a sound effect to a piece of original audio. More specifically, the background audio may be obtained by acquiring an original audio (e.g., a song) from the server, then adding some sound effects (e.g., a gunshot, a bird song, etc.) to certain given areas of the original audio. Optionally, a specific manner for adding sound effects to the original audio may comprise following steps. The original audio is put into one track, and the sound effect audio is put into another track. The position of the sound effect in the track is adjusted, so that the position at which the sound effect added to the original audio is adjusted. Finally the sound track of the original music and the sound track of the sound effect are synthesized to obtain the background audio.

Specifically, after the terminal obtains the background audio, a parsing environment is required to be provided for the terminal provided by the server, such that the terminal can play the background audio. The parsing operation may comprise performing format conversion to the background audio that may not be played by the terminal, and the like. The parsing environment may be an operation page or an APP installed on the terminal to perform the method for displaying triggered by the audio.

In step S204, the background audio is played, and a to-be-triggered area is generated in a display page in response to playing to the sound effect.

The display page is a page for displaying an output effect on the terminal, such as a screen of a mobile phone or a computer, and the like.

Specifically, after the background audio is successfully parsed in step S202, the background audio obtained by parsing can be played by the terminal. When the background audio is played to a portion where the sound effect is added, a to-be-triggered area for triggering is generated on the display page of the terminal. The to-be-triggered area may be one or more rectangular areas or circular areas generated in the display page, and the rendering effect of the to-be-triggered area may be configured according to an output requirement. For example, the edges of the rectangular area or the circular area are rendered as colored, and the like.

In step S206, an input trigger instruction is received, and whether the trigger instruction matches the to-be-triggered area is detected.

The trigger instruction is an instruction input by a user through an input device to trigger the to-be-triggered area. For example, a user can click the to-be-triggered area on the screen of a terminal (e.g., a smart phone or a tablet) through a touch screen, and a trigger instruction is sent to the terminal (e.g., a mobile phone or a tablet, etc.).

Specifically, after the terminal generates the to-be-triggered area, the user is required to send the trigger instruction that matches the to-be-triggered area to the terminal, then a corresponding display effect can be triggered. The trigger instruction to the terminal is sent by a user through an input device. After the trigger instruction is received, the terminal can detect whether the trigger instruction matches the to-be-triggered area to determine whether the corresponding trigger effect should be displayed. The method for detecting whether the trigger instruction matches the to-be-triggered area may comprise following steps: in the case where the to-be-triggered area is a rectangular areas or a circular area on the display page, if the trigger area corresponding to the trigger instruction falls within the to-be-triggered area, the terminal can then determine that the trigger instruction matches the to-be-triggered area; if the trigger area corresponding to the trigger instruction does not fall within the to-be-triggered area, the terminal can determine that the trigger instruction does not match the to-be-triggered area.

In step S208, the to-be-triggered area is displayed according to a first preset effect, in response to the trigger instruction matching the to-be-triggered area.

The first preset effect is a display effect of the to-be-triggered area triggered by a sound effect. It may be a plurality of media effects, and the display effect of the to-be-triggered area may be converted into a preset trigger effect. For example, the display effect may be changing the color of the border of the to-be-triggered area, or displaying a praised expression in the display interface, or displaying a fragmentation or disappearance effect to the rectangular areas or circular areas corresponding to the to-be-triggered area, and the like.

Specifically, when the terminal detects that the input trigger instruction matches the to-be-triggered area, a first preset effect that indicates the triggering instruction successfully triggers the to-be-triggered area is acquired, and the display effect of the to-be-triggered area is switched to the first preset effect, which is then displayed to the user of the terminal.

In the above method for displaying triggered by the audio, the terminal can play the background audio containing the sound effect. When the sound effect added thereto is played, the to-be-triggered area is generated in the display page. If a trigger instruction matching the to-be-triggered area is input by the user on the terminal, the first display effect is triggered on the display page to display the to-be-triggered area. In summary, the trigger and display of the display effect are controlled together by the sound effect in the background audio and the trigger instruction given by the user, so that the trigger of the display effect can be better integrated into the background music, thus giving the user a better experience.

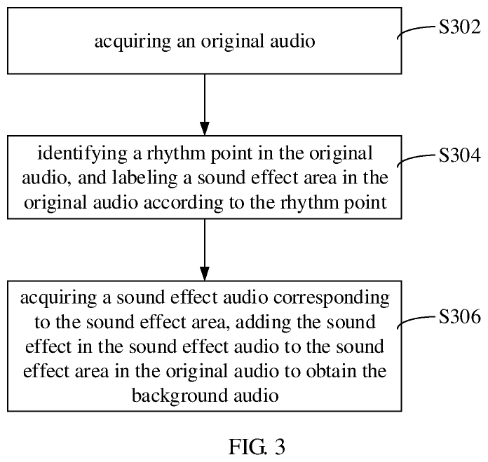

Referring to FIG. 3, in an embodiment, in the above method for displaying triggered by the audio, the manner for adding sound effects into the background audio may comprise following steps.

In step S302, an original audio is acquired.

The original audio is an audio file to which a sound effect is to-be-added, the original audio may be in a common audio format, such as mp3, WMA, WAV, etc. The original audio may be a song or a piece of music downloaded from a network resource. The original audio should be acquired first, then the sound effect can added into the original audio by a server.

In step S304, a rhythm point in the original audio is identified, and a sound effect area in the original audio is labeled according to the rhythm point.

The rhythm point is a point obtained by identifying the rhythm in the original audio by the server, which represents a rhythm corresponding to the original music. The position of the rhythm point in the original audio may be identified by the server by a given rhythm recognition rule. The rhythm recognition rule may be determined by acquiring spectrum corresponding to the original audio during playing, and capturing a repeated frequency band in the spectrum, or the rhythm recognition rule may be identified according to some factors (e.g., a strength, a volume, etc.) of the original audio during playing.

Optionally, the manner for identifying a rhythm point of the original audio by the server may include following steps: identifying a beat attribute of the original audio to obtain a beat point of the original audio; analyzing a spectrum of the original audio to obtain a feature point in the spectrum of the original audio; and matching the beat point of the original audio with the feature point in the spectrum of the original audio to obtain the rhythm point of the original audio. Specifically, the beat attribute refers to a BPM (Beat Per Minute) attribute of the original audio. The BPM in the original audio can be identified by the server by using a common music analysis software (e.g., a metronome, a MixMeister BPM Analyzer, etc.) to obtain the beat attribute of the original audio and to identify the beat point representing the beat attribute in the original audio. Further, the original audio of the song class often includes a main song, a chorus, an interlude, etc., in order to identify the rhythm attribute and to label the rhythm point of such original audio more accurately, the original song audio can be segmented according to the main song, the chorus, and the interlude. Then the audio section segmented can be identified by the BPM. At last, all of the segments of the BMP are fused, and the beat point of the original audio of the song class is finally obtained. The spectrum of the original audio is parsed according to the spectrum analysis by the server, and specifically, the spectrum parse may be performed by an analysis method such as spectrum analysis by FFT (Fast Fourier Transformation) etc., or by using spectrum analysis tools such as Cubase etc. For the acquisition of the feature points in the spectrum, it can be acquired by configuring a feature point acquisition rule. For example, a point in the spectrum where the db (decibel) is higher than a preset value obtained by empirical and experimental adjustment can be served as a feature point. The beat point obtained in step S202 and the feature points obtained in step S204 are matched by the server to obtain a rhythm point of the original audio. Optionally, a point where the beat point and the feature point are coincident may be selected as the rhythm point of the original audio. The rhythm point of the original audio is determined by double analysis of the beat attribute and spectrum of the original audio by the server, so that the acquisition of the rhythm point is more accurate.

The sound effect area is an area where the sound effect is to be added acquired according to a recognized rhythm point. The sound effect area can coincide with the rhythm point, that is, the sound effect is just added to the rhythm point of the original audio. Alternatively, it can also be adjusted according to the actual playing effect of the added sound effect, for example, it can be a time period which is set starting from the rhythm point and lasting for several seconds. After all the sound effect areas in the original audio that need to be added with sound effects are obtained by the server, the sound effect area can be represented by the time section of the original audio playing. For example, taking the time section from the first minute (1′) to the first minute two seconds (1′2″) of the original audio as a sound effect area, and taking the time section from the first minutes thirty seconds (1′30″) to the first minutes thirty three seconds (1′33″) as another sound effect area. Optionally, the length of the sound effect area may also be adjusted according to the duration of the to-be-added sound effect or the type of the rhythm point. For a sound of gunshot, the duration of the sound effect may be 1 second, then the sound effect area may be set to a time section including the rhythm point and with 1 second duration.

In step S306, a sound effect audio corresponding to the sound effect area is acquired, and the sound effect in the sound effect audio is added to the sound effect area in the original audio to obtain a background audio.

The sound effect audio is an audio file containing the sound effect added in the original audio. The sound effect can be a piece of music, or a gunshot, birdsong, etc. The sound effect audio can be in common audio formats such as mp3, WMA, WAV, etc.

Specifically, after the sound effect area of the sound effect to be added is labeled in the original audio, a sound effect audio corresponding to the sound effect synthesized in the sound effect area is acquired by the server. The sound effect audio is synthesized into the sound effect area that has been labeled in the original audio to obtain the background audio.

In the above embodiment, the sound effect in the original audio is added to the sound effect area corresponding to the rhythm point of the original audio. All of the sound effect areas that need to be inserted by the sound effect in the original audio can be identified by the server with a single step according to the rhythm recognition rule, and the sound effect can be inserted directly to the corresponding sound effect area, instead of inserting sound effects to the sound effect area one by one, as in the traditional method. Therefore the sound effect can be simply and quickly added at the rhythm points.

In an embodiment, the background audio in the method of displaying triggered by an audio is not a synthesized audio, but an original audio of a sound without synthesized and a labeled file on which several contents are labeled, such as a sound effect area with the added sound effect in the original audio and an added sound effect, etc. The acquiring background audio containing a sound effect in step S202 may comprise acquiring the original audio and a labeled file corresponding to the original audio, and the labeled file includes a sound effect audio and a sound effect section of the sound effect added to the original audio. The playing the background audio and generating the to-be-triggered area in the display page in response to playing to the sound effect audio in step S204 may comprise playing the original audio, and traversing the labeled file; and playing the sound effect audio and generating the to-be-triggered area in the display page in response to the original audio played to the sound effect section in the labeled file.

Specifically, the server generates a labeled file which may be identified by a terminal according to a relationship between all the sound effect areas identified in the original audio and the sound effect audio corresponding to the sound effect to be added when playing every sound effect area. Optionally, the sound effect audio in the labeled file may be represented by a tag, and the tag of a sound effect audio is a link-type symbol for acquiring a sound effect audio. The corresponding sound effect audio may be acquired from the preset address of the stored sound effect audio by using the tag. Other means such as word abbreviation or encoding may be adopted to represent the tag of a sound effect audio as well. After the sound effect audio corresponding to the sound effect area is obtained by the server according to several factors (i.e. a length of the sound effect section, a rhythm point attribute etc.), the tag of the sound effect is used to represent the sound effect in the labeled file. After the original audio and the labeled file corresponding to the original audio are acquired by the terminal, the corresponding sound effect audio can be acquired by the tag of the sound effect audio to play the original audio, then the timing to play the acquired sound effect audio is determined according to the sound effect section in the labeled file. The labeled file may be stored in a format of a mid file or an xml file, and the step for generating the labeled file is the step for generating a corresponding a mid file or an xml file according to the original audio.

Optionally, the labeled file may further include a non-sound effect section besides the sound effect section. The non-sound effect section is represented according to the time section when the original audio is played. For example, a labeled file of an original audio can be represented as “empty [H], c1 [k1], empty [HIJK], c2 [k2], empty [HJK], c [k1] . . . ”, where c1, c2 are the tags of the sound effect audio. The sound effect audio corresponding to c1 and c2 can be acquired from the preset address through c1 and c2, respectively. The “empty” represents a non-sound effect section, and the content in the square brackets after the “empty” represents a time section of the non-sound effect section. The content in the square bracket after the c1, c2 represents a time section of the sound effect section.

After the original audio and the labeled file corresponding to the original audio are obtained by the server according to steps in the above embodiments, the original audio and the labeled file can be correspondingly released, and then downloaded by the terminal according to the requirement. When the original audio is played, the timing to play a sound effect audio is determined by the sound effect area in the labeled file. When the original audio is played to the sound effect area, the sound effect audio is simultaneously played, thus achieving the effect of adding the sound effect to the original audio. In response to the original audio played to the sound effect area in the labeled file, the to-be-triggered area can be generated in the display page by the terminal, that is, the sound effect area in the labeled file is used as a basis for triggering the generation of the to-be-triggered area.

In the above embodiment, the sound effect inserted in the original audio is represented by a labeled file by the server, and corresponding sound effect is played in the sound effect area in the original audio by the terminal according to the labeled file, so that the effect of adding sound effect is realized, and it can be a basis for triggering the generation of the to-be-triggered area.

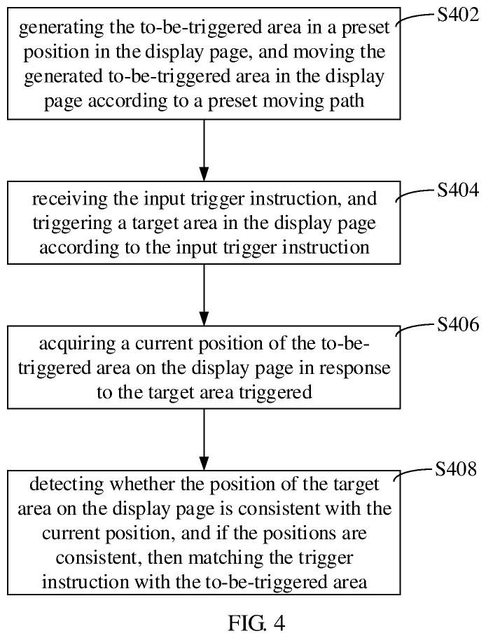

Referring to FIG. 4, in an embodiment, after generating the to-be-triggered area in the display page in above step 204, the method may further comprise a step of triggering by instruction, which may specifically comprise the following steps.

In step S402, a to-be-triggered area is generated in a preset position in the display page, and the to-be-triggered area is moved in the display page according to the preset moving path after the to-be-triggered area is generated.

The preset position is a given position when the to-be-triggered area is just generated in the display page. For example, it can be a upper position on the screen of the mobile phone, etc., which can be configured according to actual requirements.

The preset moving path is a given moving track of the to-be-triggered area in the display page. The position of the to-be-triggered area in the display page is not fixed, but can be varied according to the preset moving path. For example, the to-be-triggered area may be a block displayed on the screen of the mobile phone. The preset position of the block is an upper center position on the screen, and the preset moving path may be a track that the block drops to the lower end from the upper center position on the screen. Accordingly, the block is generated at the upper center position on the screen of the mobile phone, and the generated moving path is a path that dropping to the lower end from the center of the upper end on the screen.

The receiving an input trigger instruction and detecting whether the trigger instruction matches the to-be-triggered area in step S206 may comprise the following steps.

In step S404, an input trigger instruction is received, and a target area is triggered in the display page according to the trigger instruction.

The target area is an area that is triggered in the display page of the terminal after a trigger instruction is input by a user on the terminal. For example, when the user clicks an area on the screen of the terminal (e.g., a mobile phone or a tablet) through a touch screen, the clicked area can be served as a triggered target area, and the click operation by the user on the screen of the mobile phone can be served as an operation that the user inputs the trigger instruction.

In step S406, a current position of the to-be-triggered area is acquired on the display page in response to the target area triggered.

The position of the target area in the display page will be changed constantly when the target area is moved according to the preset moving path. In this case, when a target area in the display page is triggered, the position of the target area on the display page is served as a current position. For example, when the target area is triggered, if the block of the to-be-triggered area is moved to the center of the lowest end on the screen of the mobile phone, the position at the center of the lowest end on the screen of the mobile phone is served as the current position of the to-be-triggered area.

In step S408, whether the position of the target area on the display page is consistent with the current position is detected; if the positions are consistent, then the trigger instruction matches the to-be-triggered area.

Specifically, the manner for detecting whether the trigger instruction matches the to-be-triggered area by the terminal is to detect and determine whether the current position acquired in step S406 and the position of the target area on the display page are consistent, that is, by determining whether the target position triggered by the trigger instruction falls on the current position of the to-be-triggered area.

In the above embodiment, by setting the to-be-triggered area to move according to the preset moving path, the position of the to-be-triggered area on the display page of the terminal varies. And by detecting whether the target position triggered by the trigger instruction falls on the current position of the to-be-triggered area to detect whether the trigger instruction matches the to-be-triggered area, the complexity of the display being triggered is improved.

In an embodiment, after playing the background audio in step S204, the method may further comprise generating an initial area in the display page. And the step of triggering the target area in the display page according to the trigger instruction in step S404, may comprise moving the initial area according to the trigger instruction to get the target area.

Specifically, in step S204, after the terminal starts to play the background audio, an initial area is generated in the display page of the terminal. The initial area is a fixed position with a preset shape in the display page. For example, the initial area can be set as a square area in the lowest center on the screen of the mobile phone. The position of the initial area in the display page is changed by an input trigger instruction to obtain a target area, so that the position of the target area on the display page is consistent with the current position of the to-be-triggered area moving in the display page. Thus the condition for presetting a multimedia information display is achieved, and the corresponding display effect is displayed in the display page.

In the above embodiment, the initial area can be manipulated through a trigger instruction input by user, so that the condition for presetting a preset multimedia information display is achieved, and the user's participation experience is improved.

In an embodiment, after generating the to-be-triggered area in the display page in step S204, the method may further comprise acquiring a second preset effect in response to the trigger instruction matching the to-be-triggered area is not received after a preset duration; and displaying the to-be-triggered area according to the second preset effect.

The second preset effect is an effect of displaying an unmatched to-be-triggered area, and the display effect of the second preset effect may be the same as that of the first preset effect. For example, the first and second display effects can be both set as an effect that the rectangular shape or circular shape corresponding to the to-be-triggered area is fragmented and disappeared. The second preset effect may also be different from the first preset effect. For example, the first preset effect is set as the rectangular shape corresponding to the to-be-triggered area fragmented and disappeared, and the second preset effect is set as the rectangular shape corresponding to the to-be-triggered becoming faded until disappeared in the display page.

If the trigger instruction input by the user cannot be received by the terminal within a preset duration, or the trigger instruction input by the user does not match the to-be-triggered area, the second preset effect will be acquired by the terminal to display the to-be-triggered area. The preset duration may be set according to the preset moving path of the to-be-triggered area in step S402. For example, the preset duration may be set as the time of moving the block of the to-be-triggered area from the top end to the bottom end of the display page. If a trigger instruction that matches the to-be-triggered area has not been received until the block is moved to the bottom end of the display page, the to-be-triggered area will be displayed with the second preset effect, for example, disappearing from the display page.

In the above embodiment, for a to-be-triggered area that is not triggered, a second preset effect is displayed by the terminal, indicating that this trigger is missed by the user.

In an embodiment, after displaying the to-be-triggered area according to a first preset effect in step S208, the method may further comprise: counting a number of times that the trigger instruction matches the to-be-triggered area, and outputting the counting result in response to exiting the display page.

Specifically, for a background audio, it may include multiple sound effect areas, that is, a to-be-triggered area may be generated multiple times on the display page. After each time the to-be-triggered area is generated, a trigger instruction is required to be input by user to trigger the to-be-triggered area. In order to improve the user's participation, the number of times of successfully triggered by user can be counted, and when exiting the display page, the counting result is output.

In the above embodiment, the number of times of successfully triggered by user can be counted by the terminal, and counting result can be displayed to the user, so that the user's participation experience is improved.

In an embodiment, the method for displaying triggered by an audio may be further developed to create a mobile game with audio-visual combination and high human-machine interaction. The operation of the game may include the following steps. After installing the game on the mobile terminal, the mobile phone can provide users with a variety of background audio to choose in the initial interface of the game. These background audios are obtained by adding sound effects such as gunshots at the rhythm point of the original music by the game development side, and are released on the server side. The background audios released on the server side can be downloaded by mobile phone user and parsed through the game initial interface, then the parsed background audio is played on the mobile phone. After a background audio to play is selected by a mobile phone user, the game operation interface can be accessed. The game operation interface may comprise: a square area in the center of the lower part on the screen (i.e., an initial area available for user operation) and a position change area of the to-be-triggered area. When the background audio is played to the sound effect section added thereto, the sound effect is triggered to generate a to-be-triggered area on the screen. In order to distinguish, the display effect of the to-be-triggered area may be set different from that of the initial area. For example, the initial area can be set as a transparent square with a frame, and the to-be-triggered area can be set as a colorful opaque square, etc. After generated, the to-be-triggered area is moved in the position change area of the to-be-triggered area according to the preset moving path, and the user can manipulate the initial area to capture the to-be-triggered area, then a “hit” is realized. When a “hit” is realized, a hit effect is also displayed on the screen, for example, the hit effect can be the colored square corresponding to the to-be-triggered area is fragmented and disappeared, etc. The number of times of the hits of the user can be counted in the background as the user's current game score. When the background audio ends or there are too many times of miss-hits of the user, the game is considered to be failed, then the terminal exits the display page of the game, and the game score is displayed to the user. In addition, user can also end the game with an exit button before the background audio ends.

It should be understood that although the various steps in the flowcharts of FIG. 2 to FIG. 4 are sequentially displayed as indicated by the arrows, these steps are not necessarily executed in the order indicated by the arrows. Except as explicitly stated herein, the execution of these steps is not strictly limited, and the steps may be executed in other orders. Moreover, at least some of the steps in FIG. 2 to FIG. 4 may comprise a plurality of sub-steps or stages, which are not necessarily executed at the same time, but may be executed at different times. The order of execution of these sub-steps or stages is not necessarily performed sequentially, but may be performed alternately or alternately with at least a portion of other steps or sub-steps or stages of other steps.

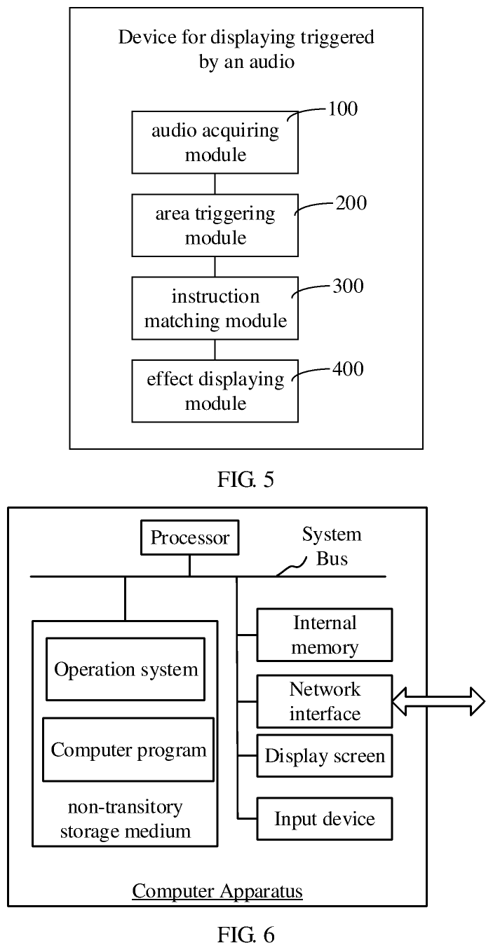

In one embodiment, as shown in FIG. 5, a device for displaying triggered by an audio is provided. The device includes an audio acquiring module 100, an area triggering module 200, an instruction matching module 300, and an effect displaying module 400.

The audio acquiring module 100 is configured to acquire a background audio containing a sound effect.

The area triggering module 200 is configured to play the background audio in response to playing to the sound effect, a to-be-triggered area in the display page is generated.

The instruction matching module 300 is configured to receive an input trigger instruction and detect whether the trigger instruction matches the to-be-triggered area.

The effect displaying module 400 is configured to display the to-be-triggered area according to a first preset effect in response to the trigger instruction matching the to-be-triggered area.

In an embodiment, the above device for displaying triggered by an audio may further include an original audio acquiring module, a rhythm area labeling module, and a background audio generating module.

The original audio acquiring module is configured to acquire an original audio.

The rhythm area labeling module is configured to identify rhythm points in the original audio, and label the sound effect area in the original audio according to the rhythm points.

The background audio generating module is configured to obtain a sound effect audio corresponding to the sound effect area, and add the sound effect in the sound effect audio to the sound effect area in the original audio to obtain the background audio.

In an embodiment, the audio acquiring module 100 in the device for displaying triggered by an audio may further be configured to obtain an original audio and a labeled file corresponding to the original audio. The labeled file includes a sound effect audio and a sound effect section in the original audio added with the sound effect. The above area triggering module 200 may include a playing unit and a triggering unit.

The playing unit is configured to play the original audio and traverse the labeled file.

The triggering unit is configured to play the sound effect audio when the original audio is played to the sound effect section in the labeled file, and generate a to-be-triggered area in the display page.

In an embodiment, the area triggering module 200 is further configured to generate a to-be-triggered area in a preset position in the display page, and move the generated to-be-triggered area in the display page according to a preset moving path.

The above instruction matching module 300 may include an instruction receiving unit, a current location acquiring unit, and a match detecting unit.

The instruction receiving unit is configured to receive an input trigger instruction, and trigger the target area in the display page according to the trigger instruction.

The current location acquiring unit is configured to acquire a current position of the to-be-triggered area on the display page in response to the target area triggered.

The match detecting unit is configured to detect whether the position of the target area on the display page is consistent with the current position; if the position is consistent, matching the trigger instruction to the to-be-triggered area.

In an embodiment, the above device for displaying triggered by an audio may further include an initial area generating module, which is configured to generate an initial area in the display page. And the instruction receiving unit may be further configured to move the initial area according to the trigger instruction to obtain a target area.

In an embodiment, the above device for displaying triggered by an audio may further include a timeout module and a timeout triggering module.

The timeout module is configured to acquire a second preset effect in response to the trigger instruction matching the to-be-triggered area is not received after a preset duration.

The timeout triggering module is configured to display the to-be-triggered area according to the second preset effect.

In an embodiment, the above device for displaying triggered by an audio may further include a counting module, which is configured to count a number of times that the trigger instruction matches the to-be-triggered area, and output the counting result in response to exiting the display page.

For a specific feature of the device for displaying triggered by an audio, it may refer to the above description of the method for displaying triggered by an audio, and the details will not be described herein. The various modules in the above device for displaying triggered by an audio may be implemented in whole or in part by software, hardware, and combinations thereof. Each of the above modules may be in the form of hardware which may be embedded in or independent of the processor in the computer apparatus, or may be in the form of software which may be stored in a memory in the computer apparatus, so that the processor can invoke the operations corresponding to the above modules.

In one embodiment, a computer apparatus is provided. The computer apparatus may be a terminal, and the internal structure diagram is shown in FIG. 6. The computer apparatus includes a processor, a memory, a network interface, a display screen, and an input device, which are connected by a system bus. The processor of the computer apparatus is configured to provide computing and controlling capabilities. The memory of the computer apparatus includes a non-transitory computer-readable storage medium and an internal memory. The non-transitory computer-readable storage medium stores an operating system and computer-readable instructions. The internal memory provides an environment for operation of an operating system and computer-readable instructions in a non-transitory computer-readable storage medium. The network interface of the computer apparatus is configured to communicate with an external terminal via a network connection. The computer-readable instructions are executed by the processor to implement a method for displaying triggered by an audio. The display screen of the computer apparatus may be a liquid crystal display or an electronic ink display screen. The input device of the computer apparatus may be a touch layer covered on a display screen, or may be a button, a trackball or a touch pad provided on a computer apparatus case. It can also be an external keyboard, a touchpad or a mouse.

It will be understood by those skilled in the art that the structure shown in FIG. 6 is only a block diagram of a part of the structure related to the solution of the present disclosure, and does not constitute a limitation of the computer apparatus to which the solution of the present disclosure is applied. The specific computer apparatus may include more or fewer components than those shown in the figure, or have some components combined, or have different component arrangements.

In one embodiment, a computer apparatus is provided. The computer apparatus comprises one or more processors, and a memory storing computer-readable instructions, which, when executed by the one or more processors cause the one or more processors to perform steps comprising: acquiring a background audio containing a sound effect; playing the background audio, and generating a to-be-triggered area in a display page in response to playing to the sound effect; receiving an input trigger instruction, and detecting whether the trigger instruction matches the to-be-triggered area; and displaying the to-be-triggered area according to a first preset effect in response to the trigger instruction matching the to-be-triggered area.

In an embodiment, the acquiring the background audio containing the sound effect, which is realized when the computer-readable instructions executed by the one or more processors may further comprise: acquiring an original audio; identifying a rhythm point in the original audio, and labeling a sound effect area in the original audio according to the rhythm point; and acquiring a sound effect audio corresponding to the sound effect area, adding the sound effect in the sound effect audio to the sound effect area in the original audio to obtain the background audio.

In one embodiment, the background audio comprises an original audio and a labeled file corresponding to the original audio. The acquiring the background audio containing the sound effect, which is realized when the computer-readable instructions executed by the one or more processors may further comprise: acquiring the original audio and a labeled file corresponding to the original audio, the labeled file comprising a sound effect audio and a sound effect section of the sound effect added to the original audio; wherein the playing the background audio, and generating the to-be-triggered area in the display page in response to playing to the sound effect comprises: playing the original audio and traversing the labeled file; and playing the sound effect audio, and generating the to-be-triggered area in the display page, in response to the original audio playing to the sound effect section of the labeled file.

In an embodiment, the generating the to-be-triggered area in the display page, which is realized when the computer-readable instructions executed by the one or more processors may further comprise: generating the to-be-triggered area in a preset position in the display page, and moving the generated to-be-triggered area in the display page according to a preset moving path. And the receiving an input trigger instruction, and detecting whether the trigger instruction matches the to-be-triggered area which is realized when the computer-readable instructions executed by the one or more processors may comprise: receiving the input trigger instruction, and triggering a target area in the display page according to the input trigger instruction; acquiring a current position of the to-be-triggered area on the display page in response to the target area triggered; and detecting whether the position of the target area on the display page is consistent with the current position, and if the positions are consistent, then matching the trigger instruction with the to-be-triggered area.

In an embodiment, after the playing the background audio, which is realized when the computer-readable instructions executed by the one or more processors may further comprise: generating an initial area in the display page. And the triggering the target area in the display page according to the trigger instruction, which is realized when the computer-readable instructions executed by the one or more processors may comprise: moving the initial area according to the trigger instruction to obtain the target area.

In an embodiment, after the generating the to-be-triggered area in the display page, which is realized when the computer-readable instructions executed by the one or more processors, the processor is further caused to implement: acquiring a second preset effect in response to the trigger instruction matching the to-be-triggered area is not received after a preset duration; and displaying the to-be-triggered area according to the second preset effect.

In an embodiment, after the displaying the to-be-triggered area according to the first preset effect, which is realized when the computer-readable instructions executed by the one or more processors, the processor is further caused to implement: counting a number of times that the trigger instruction matches the to-be-triggered area, and outputting a counting result in response to exiting the display page.

In one embodiment, a non-transitory computer-readable storage medium is provided. The non-transitory computer-readable storage medium comprises computer-readable instructions, which, when executed by one or more processors, cause the one or more processors to perform steps comprising: acquiring a background audio containing a sound effect; playing the background audio, and generating a to-be-triggered area in a display page in response to playing to the sound effect; receiving an input trigger instruction, and detecting whether the trigger instruction matches the to-be-triggered area; and displaying the to-be-triggered area according to a first preset effect in response to the trigger instruction matching the to-be-triggered area.

In an embodiment, the acquiring the background audio containing the sound effect, which is realized when the computer-readable instructions executed by the one or more processors may further comprise: acquiring an original audio; identifying a rhythm point in the original audio, and labeling a sound effect area in the original audio according to the rhythm point; and acquiring a sound effect audio corresponding to the sound effect area, adding the sound effect in the sound effect audio to the sound effect area in the original audio to obtain the background audio.

In one embodiment, the background audio comprises an original audio and a labeled file corresponding to the original audio; the acquiring the background audio containing the sound effect, which is realized when the computer-readable instructions executed by the one or more processors may further comprise: acquiring the original audio and a labeled file corresponding to the original audio, the labeled file comprising a sound effect audio and a sound effect section of the sound effect added to the original audio; wherein the playing the background audio, and generating the to-be-triggered area in the display page in response to playing to the sound effect comprises: playing the original audio and traversing the labeled file; and playing the sound effect audio, and generating the to-be-triggered area in the display page, in response to the original audio playing to the sound effect section of the labeled file.

In an embodiment, the generating the to-be-triggered area in the display page, which is realized when the computer-readable instructions executed by the one or more processors may further comprise: generating the to-be-triggered area in a preset position in the display page, and moving the generated to-be-triggered area in the display page according to a preset moving path. And the receiving an input trigger instruction, and detecting whether the trigger instruction matches the to-be-triggered area, which is realized when the computer-readable instructions executed by the one or more processors may comprise: receiving the input trigger instruction, and triggering a target area in the display page according to the input trigger instruction; acquiring a current position of the to-be-triggered area on the display page in response to the target area triggered; and detecting whether the position of the target area on the display page is consistent with the current position, and if the positions are consistent, then matching the trigger instruction with the to-be-triggered area.

In an embodiment, after the playing the background audio, which is realized when the computer-readable instructions executed by the one or more processors, the processor is further caused to implement: generating an initial area in the display page. And the triggering the target area in the display page according to the trigger instruction, which is realized when the computer-readable instructions executed by the one or more processors may comprise: moving the initial area according to the trigger instruction to obtain the target area.

In an embodiment, after the generating the to-be-triggered area in the display page, which is realized when the computer-readable instructions executed by the one or more processors, the processor is further caused to implement: acquiring a second preset effect in response to the trigger instruction matching the to-be-triggered area is not received after a preset duration; and displaying the to-be-triggered area according to the second preset effect.

In an embodiment, after the displaying the to-be-triggered area according to the first preset effect, which is realized when the computer-readable instructions executed by the one or more processors, the processor is further caused to implement: counting a number of times that the trigger instruction matches the to-be-triggered area, and outputting a counting result in response to exiting the display page.

A person skilled in the art should understand that the processes of the methods in the above embodiments could be, in full or in part, implemented by computer-readable instructions instructing underlying hardware. The computer-readable instructions can be stored in a computer-readable storage medium and executed by at least one processor in the computer operating system. The computer-readable instructions can include the processes in the embodiments of the various methods when it is being executed. Any references to memory, storage, databases, or other media used in various embodiments provided herein may include non-transitory and/or transitory computer-readable storage medium. Non-transitory computer-readable storage medium can include read only memory (ROM), programmable ROM (PROM), electrically programmable ROM (EPROM), electrically erasable programmable ROM (EEPROM), or flash memory. Transitory computer-readable storage medium may include random access memory (RAM) or external high-speed cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), synchronization chain Synchlink DRAM (SLDRAM), memory Bus (Rambus) direct RAM (RDRAM), direct memory bus dynamic RAM (DRDRAM), and memory bus dynamic RAM (RDRAM).

Those skilled in the art can apparently appreciate upon reading the disclosure of this application that the respective technical features involved in the respective embodiments can be combined arbitrarily between the respective embodiments as long as they have no collision with each other. Of course, the respective technical features mentioned in the same embodiment can also be combined arbitrarily as long as they have no collision with each other.

The foregoing implementations are merely specific embodiments of the present disclosure, and are not intended to limit the protection scope of the present disclosure. It should be noted that any variation or replacement readily figured out by persons skilled in the art within the technical scope disclosed in the present disclosure should all fall into the protection scope of the present disclosure. Therefore, the protection scope of the present disclosure shall be subject to the protection scope of the claims.

What is claimed is:

1. A method for displaying triggered by an audio, the method comprising:
acquiring a background audio containing a sound effect;
playing the background audio, and generating a to-be-triggered area in a display page in response to playing to the sound effect;
receiving an input trigger instruction, and detecting whether the trigger instruction matches the to-be-triggered area; and
displaying the to-be-triggered area according to a first preset effect in response to the trigger instruction matching the to-be-triggered area.

2. The method of claim 1, wherein the acquiring the background audio containing the sound effect comprises:
acquiring an original audio;
identifying a rhythm point in the original audio, and labeling a sound effect area in the original audio according to the rhythm point; and
acquiring a sound effect audio corresponding to the sound effect area, adding the sound effect in the sound effect audio to the sound effect area in the original audio to obtain the background audio.

3. The method of claim 2, wherein the identifying the rhythm point in the original audio comprises:
identifying a beat attribute of the original audio to obtain a beat point of the original audio;
analyzing a spectrum of the original audio to obtain a feature point in the spectrum of the original audio; and
matching the beat point of the original audio with the feature point in the spectrum of the original audio to obtain the rhythm point of the original audio.

4. The method of claim 1, wherein the background audio comprises an original audio and a labeled file corresponding to the original audio; the acquiring the background audio containing the sound effect comprises:
acquiring the original audio and the labeled file corresponding to the original audio, the labeled file comprising a sound effect audio and a sound effect section of the sound effect added to the original audio;
wherein the playing the background audio, and generating the to-be-triggered area in the display page in response to playing to the sound effect comprises:
playing the original audio and traversing the labeled file; and
playing the sound effect audio, and generating the to-be-triggered area in the display page, in response to the original audio playing to the sound effect section of the labeled file.

5. The method of claim 1, wherein the generating the to-be-triggered area in the display page comprises:
generating the to-be-triggered area in a preset position in the display page, and moving the generated to-be-triggered area in the display page according to a preset moving path;
wherein the receiving the input trigger instruction, and detecting whether the trigger instruction matches the to-be-triggered area comprises:
receiving the input trigger instruction, and triggering a target area in the display page according to the input trigger instruction;
acquiring a current position of the to-be-triggered area on the display page in response to the target area triggered; and
detecting whether the position of the target area on the display page is consistent with the current position, and if the positions are consistent, then matching the trigger instruction with the to-be-triggered area.

6. The method of claim 5, wherein after the playing the background audio, the method further comprises:
generating an initial area in the display page;
wherein the triggering the target area in the display page according to the trigger instruction comprises:
moving the initial area according to the trigger instruction to obtain the target area.

7. The method of claim 1, wherein after the generating the to-be-triggered area in the display page, the method further comprises:
acquiring a second preset effect in response to the trigger instruction matching the to-be-triggered area is not received after a preset duration; and
displaying the to-be-triggered area according to the second preset effect.

8. The method of claim 1, wherein after the displaying the to-be-triggered area according to the first preset effect, the method further comprises:
counting a number of times that the trigger instruction matches the to-be-triggered area, and outputting a counting result in response to exiting the display page.

9. A computer apparatus, comprising:
one or more processors, and
a memory storing computer-readable instructions, which, when executed by the one or more processors cause the one or more processors to perform steps comprising:
acquiring a background audio containing a sound effect;
playing the background audio, and generating a to-be-triggered area in a display page in response to playing to the sound effect;
receiving an input trigger instruction, and detecting whether the trigger instruction matches the to-be-triggered area; and
displaying the to-be-triggered area according to a first preset effect in response to the trigger instruction matching the to-be-triggered area.

10. The computer apparatus of claim 9, wherein the acquiring the background audio containing the sound effect further comprises:
acquiring an original audio;
identifying a rhythm point in the original audio, and labeling a sound effect area in the original audio according to the rhythm point; and
acquiring a sound effect audio corresponding to the sound effect area, adding the sound effect in the sound effect audio to the sound effect area in the original audio to obtain the background audio.

11. The computer apparatus of claim 9, wherein the background audio comprises an original audio and a labeled file corresponding to the original audio; the acquiring the background audio containing the sound effect further comprises:
acquiring the original audio and a labeled file corresponding to the original audio, the labeled file comprising a sound effect audio and a sound effect section of the sound effect added to the original audio;
wherein the playing the background audio, and generating the to-be-triggered area in the display page in response to playing to the sound effect comprises:
playing the original audio and traversing the labeled file; and
playing the sound effect audio, and generating the to-be-triggered area in the display page, in response to the original audio playing to the sound effect section of the labeled file.

12. The computer apparatus of claim 9, wherein the generating the to-be-triggered area in the display page further comprises:
generating the to-be-triggered area in a preset position in the display page, and moving the generated to-be-triggered area in the display page according to a preset moving path;
wherein the receiving an input trigger instruction, and detecting whether the trigger instruction matches the to-be-triggered area comprises:
receiving the input trigger instruction, and triggering a target area in the display page according to the input trigger instruction;
acquiring a current position of the to-be-triggered area on the display page in response to the target area triggered; and
detecting whether the position of the target area on the display page is consistent with the current position, and if the positions are consistent, then matching the trigger instruction with the to-be-triggered area.

13. The computer apparatus of claim 12, wherein after the playing the background audio, the memory storing computer-readable instructions, which, when executed by the one or more processors cause the one or more processors to perform steps comprising:
generating an initial area in the display page;
wherein the triggering the target area in the display page according to the trigger instruction comprises:
moving the initial area according to the trigger instruction to obtain the target area.

14. The computer apparatus of claim 9, wherein after the generating the to-be-triggered area in the display page, the memory storing computer-readable instructions, which, when executed by the one or more processors cause the one or more processors to perform steps comprising:
acquiring a second preset effect in response to the trigger instruction matching the to-be-triggered area is not received after a preset duration; and
displaying the to-be-triggered area according to the second preset effect.

15. The computer apparatus of claim 9, wherein after the displaying the to-be-triggered area according to the first preset effect, the memory storing computer-readable instructions, which, when executed by the one or more processors cause the one or more processors to perform steps comprising:
counting a number of times that the trigger instruction matches the to-be-triggered area; and
outputting a counting result in response to exiting the display page.

16. At least one non-transitory computer-readable storage medium comprising computer-readable instructions, which, when executed by one or more processors, cause the one or more processors to perform steps comprising:
acquiring a background audio containing a sound effect;
playing the background audio, and generating a to-be-triggered area in a display page in response to playing to the sound effect;
receiving an input trigger instruction, and detecting whether the trigger instruction matches the to-be-triggered area; and
displaying the to-be-triggered area according to a first preset effect in response to the trigger instruction matching the to-be-triggered area.

17. The storage medium of claim 16, wherein the acquiring the background audio containing the sound effect further comprises:
acquiring an original audio;
identifying a rhythm point in the original audio, and labeling a sound effect area in the original audio according to the rhythm point; and
acquiring a sound effect audio corresponding to the sound effect area, adding the sound effect in the sound effect audio to the sound effect area in the original audio to obtain the background audio.

18. The storage medium of claim 16, wherein the background audio comprises an original audio and a labeled file corresponding to the original audio; the acquiring the background audio containing the sound effect further comprises:
acquiring the original audio and a labeled file corresponding to the original audio, the labeled file comprising a sound effect audio and a sound effect section of the sound effect added to the original audio;
wherein the playing the background audio, and generating the to-be-triggered area in the display page in response to playing to the sound effect comprises:
playing the original audio and traversing the labeled file; and
playing the sound effect audio, and generating the to-be-triggered area in the display page, in response to the original audio playing to the sound effect section of the labeled file.

19. The storage medium of claim 16, wherein the generating the to-be-triggered area in the display page further comprises:
generating the to-be-triggered area in a preset position in the display page, and moving the generated to-be-triggered area in the display page according to a preset moving path;
wherein the receiving an input trigger instruction, and detecting whether the trigger instruction matches the to-be-triggered area comprises:
receiving the input trigger instruction, and triggering a target area in the display page according to the input trigger instruction;
acquiring a current position of the to-be-triggered area on the display page in response to the target area triggered; and
detecting whether the position of the target area on the display page is consistent with the current position, and if the positions are consistent, then matching the trigger instruction with the to-be-triggered area.

20. The storage medium of claim 16, wherein after the generating the to-be-triggered area in the display page, the computer-readable instructions, which, when executed by the one or more processors cause the one or more processors to perform steps comprising:
acquiring a second preset effect in response to the trigger instruction matching the to-be-triggered area is not received after a preset duration; and
displaying the to-be-triggered area according to the second preset effect.
